(19) United States
(12) Patent Application Publication
(10) Pub. No.: US 2011/0029365 A1
(43) Pub. Date: Feb. 3, 2011

(54) Targeting Multimedia Content Based On Authenticity Of Marketing Data

(75) Inventors: Laurent Daniel Alhadeff, New York, NY (US); Richard Adam Smullen, New York, NY (US)

Correspondence Address: Ashok Tankha, 36 Greenleigh Drive, Sewell, NJ, 08080, US

(73) Assignee: Beezag Inc.

(21) Appl. No.: 12/844,177

(22) Filed: Jul. 27, 2010

Related U.S. Application Data
(63) Continuation-in-part of application No. 12/544,233, filed on Aug. 20, 2009.
Application No. 12/544,233 is a continuation-in-part of application No. 12/822,526, filed on Jun. 24, 2010.
Application No. 12/822,526 is a continuation-in-part of application No. 12/829,636, filed on Jul. 2, 2010.
(60) Provisional application No. 61/228,974, filed on Jul. 28, 2009.
(60) Provisional application No. 61/228,981, filed on Jul. 28, 2009.

(51) Int. Cl. G06Q 30/00; G06Q 10/00

(52) U.S. Cl. 705/14.23; 705/1.1

(57) ABSTRACT

A computer implemented method and system for targeting multimedia content based on authenticity of a user's marketing data, are provided. A multimedia distribution platform acquires marketing data from the user via an interactive interface. The multimedia distribution platform determines authenticity of the user's acquired marketing data by presenting multiple marketing specific challenges to the user based on the user's acquired marketing data, obtaining responses to the marketing specific challenges from the user, and analyzing the obtained responses using one or more marketing databases. The multimedia distribution platform rates the user's acquired marketing data based on the determined authenticity. The multimedia distribution platform targets the multimedia content to the user based on the determined authenticity and/or the rating of the user's acquired marketing data. The multimedia distribution platform confirms viewing of the targeted multimedia content and compensates the user based on the view confirmation and/or rating of the acquired marketing data.

### CROSS REFERENCE TO RELATED APPLICATIONS

This application claims the benefit of the following patent applications:
1. Provisional patent application No. 61/228,974, titled “Targeting Multimedia Content Based On Authenticity Of Marketing Data” filed on Jul. 28, 2009 in the United States Patent and Trademark Office.
2. Provisional patent application No. 61/228,981, titled “Marketing By Distribution Of Multimedia Content” filed on Jul. 28, 2009 in the United States Patent and Trademark Office.
3. Continuation-in-part application Ser. No. 12/544,233, titled “Multimedia Content Viewing Confirmation” filed on Aug. 20, 2009 in the United States Patent and Trademark Office.
4. Continuation-in-part application Ser. No. 12/822,526, titled “View Confirmation For On-demand Multimedia Content” filed on Jun. 24, 2010 in the United States Patent and Trademark Office.
5. Continuation-in-part application Ser. No. 12/829,636, titled “Virtual Community For Incentivized Viewing Of Multimedia Content” filed on Jul. 2, 2010 in the United States Patent and Trademark Office.
   The specifications of the above referenced applications are incorporated herein by reference in their entirety.

### BACKGROUND

Conventional advertising strategies involve advertisers attempting to provide multimedia content, for example, advertisements to end users. Often the end users who receive the multimedia content from advertisers have an option of disregarding the multimedia content. The advertisers can leverage greater attention from the end users to the products and services provided by the advertisers, if the multimedia content provided to the end user relates to the needs and requirements of the end user. There is a need for leveraging the attention of the end users by providing the end users with attractive rewards. Furthermore, there is a need for acquiring relevant information on the end users who may be potential purchasers of products and services for targeting relevant multimedia content to the end users.

Conventional advertising strategies do not provide for an accurate matching of the multimedia content provided to the end users based on the requirements of the end users. End users may completely ignore the targeted multimedia content, or the end users form negative impressions on the advertised products and services when they are targeted with multimedia content irrelevant to the end users' needs or requirements. There is a need for acquiring accurate and authentic user information or marketing data so that the advertisers can narrow down end users to target highly relevant multimedia content to the end users. Furthermore, the acquired user information may change over a period of time. For example, the end user may relocate to a new place. In such cases, there is a need to acquire authentic user information periodically from the end users so that the user information acquired from the end users is accurate, reliable, and valid for targeting. Furthermore, there is a need to target the multimedia content to the end users based on the reliability of the acquired user information.

Hence, there is a long felt but unresolved need for a computer implemented method and system that targets multimedia content based on authenticity of marketing data of a user by obtaining accurate and reliable user information.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for targeting multimedia content based on authenticity of marketing data of a user. The computer implemented method and system disclosed herein generates accurate and reliable marketing data of the user by identifying and rectifying inconsistencies in the marketing data of the user. The accurate and reliable marketing data enhances the outreach of multimedia content owners, for example, advertisers to target highly relevant multimedia content to the right users and potential buyers. The computer implemented method and system disclosed herein enhances the quality, reliability, and accuracy of the user's marketing data by communicating with marketing databases.

In the computer implemented method and system disclosed herein, a multimedia distribution platform comprising an interactive interface is provided. The multimedia distribution platform acquires marketing data comprising, for example, demographic data, psychographic data, and behavioral data, etc. from the user via the interactive interface. In an embodiment, the user creates a user account on the multimedia distribution platform, wherein the user opts in to receive the multimedia content during the creation of the user account. The multimedia distribution platform determines authenticity of the user's acquired marketing data, for example, by presenting one or more marketing specific challenges to the user on the interactive interface based on the acquired marketing data, obtaining one or more responses to the marketing specific challenges from the user via the interactive interface, and analyzing the obtained responses using one or more marketing databases. The multimedia distribution platform rates the acquired marketing data of the user based on the determined authenticity. The multimedia distribution platform targets the multimedia content to the user based on one or more of the determined authenticity and the rating of the acquired marketing data of the user. The multimedia distribution platform targets the multimedia content to the user based on, for example, preferences selected by the user, the acquired marketing data of the user, the determined authenticity, the rating of the acquired marketing data of the user, external marketing data obtained from one or more marketing databases, etc.

The multimedia distribution platform identifies and rectifies inconsistencies in the acquired marketing data of the user using one or more marketing databases. The multimedia distribution platform identifies the inconsistencies in the acquired marketing data of the user, for example, by presenting one or more additional marketing specific challenges to the user on the interactive interface. The rating of the user's acquired marketing data may be used for further targeting multimedia content to the user, adjusting the user's demographic grouping, or triggering additional marketing specific challenges to rectify inconsistencies in the user's responses. In this embodiment, the multimedia distribution platform rates the acquired marketing data of the user based on the identified and rectified inconsistencies, and targets the multimedia content to the user based on the rating of the acquired marketing data of the user. The multimedia distribution platform provides recommendations to the user for improving the rating of the acquired marketing data of the user. The multimedia distribution platform performs a multivariate analysis for providing feedback on authenticity of the acquired marketing data. For example, the multimedia distribution platform provides feedback to multimedia content owners on what questions are more likely to be answered authentically by a particular demographic group of users.

The multimedia distribution platform varies the rating of the acquired marketing data of the user based on inconsistencies in the acquired marketing data of the user, the marketing specific challenges, time, purchase information, etc. The multimedia distribution platform utilizes the acquired marketing data, the marketing databases, and the rating for generating additional marketing specific challenges to determine authenticity of the acquired marketing data of the user.

In an embodiment, the multimedia distribution platform confirms viewing of the targeted multimedia content on a client device of the user, using, for example, a random challenge. The computer implemented method and system disclosed herein provides a view confirmation module for confirming the viewing of the targeted multimedia content by the user. The view confirmation module generates a random challenge that is, for example, random in content, presented at random times during and/or after play of the targeted multimedia content, and presented at random physical locations on the targeted multimedia content. The view confirmation module presents the generated random challenge to the user by overlaying the generated random challenge on the targeted multimedia content or inserting the generated random challenge on interruption of the play of the targeted multimedia content. The view confirmation module invokes a response from the user for the presented random challenge, and generates a response report based on the response from the user. The response determines whether the user has viewed the targeted multimedia content.

In another embodiment, the multimedia distribution platform compensates the user by crediting the user with one or more items of value based on the viewing of the targeted multimedia content and/or the rating of the acquired marketing data of the user. The multimedia distribution platform determines the number of items of value to be credited to the user based on the rating of the acquired marketing data of the user. The compensation of the user is based on, for example, the user opting to receive the targeted multimedia content from the multimedia distribution platform, the user confirming the viewing of the targeted multimedia content, the user referring the targeted multimedia content to one or more other users, etc. The multimedia distribution platform presents a commercial transaction opportunity for the user for enabling the user to purchase one or more products and services using the credited items of value.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for targeting multimedia content based on authenticity of marketing data of a user.

FIG. 2 illustrates a computer implemented method for targeting multimedia content based on authenticity of marketing data of a user and compensating the user based on viewing of the targeted multimedia content.

FIG. 3 illustrates an embodiment of the computer implemented method for targeting multimedia content based on authenticity of marketing data of a user.

FIG. 4 illustrates a computer implemented system for targeting multimedia content based on authenticity of marketing data of a user.

FIG. 5 exemplarily illustrates the architecture of a computer system employed on a client device and a multimedia distribution platform.

FIGS. 6A-6I exemplarily illustrate screenshots of an interactive interface provided by the multimedia distribution platform.

FIG. 7 exemplarily illustrates a flow diagram for targeting multimedia content to a user based on authenticity of marketing data of the user.

FIG. 8 exemplarily illustrates a sample pseudocode for targeting multimedia content to a user based on a reliability rating of the acquired marketing data of the user.

FIG. 9 exemplarily illustrates another sample pseudocode for targeting multimedia content to a user based on a reliability rating of the acquired marketing data of the user.

### DETAILED DESCRIPTION OF THE INVENTION

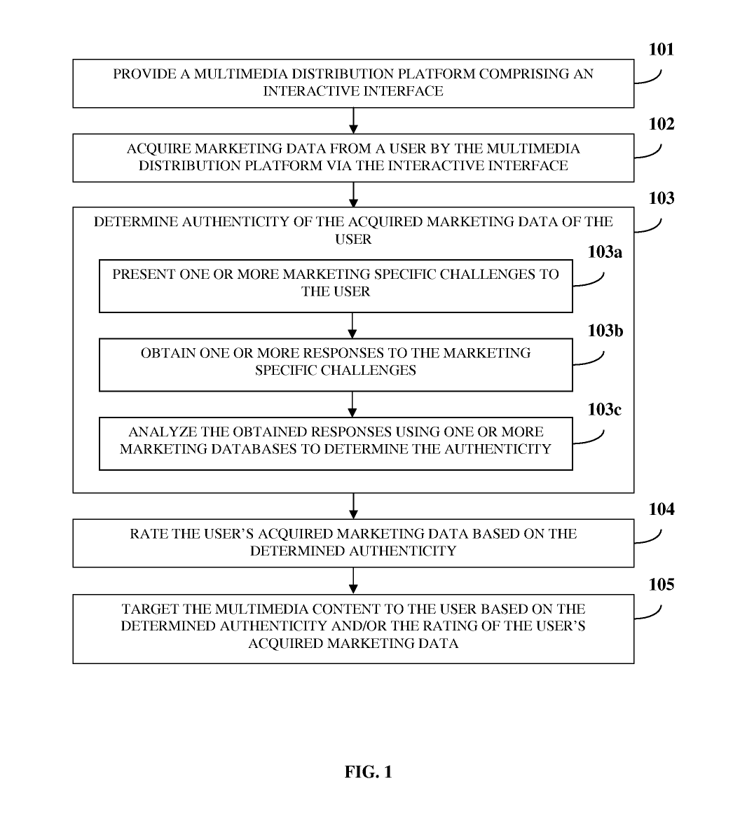

FIG. 1 illustrates a computer implemented method for targeting multimedia content based on authenticity of marketing data of a user. As used herein, the term “multimedia content” refers to content in different combined and individual formats, for example, text, audio, video, audiovisual, still images, animations, and rich content formats. The computer implemented method disclosed herein provides 101 a multimedia distribution platform comprising an interactive interface to the user. The multimedia distribution platform is, for example, administered by a media service provider. As used herein, “media service provider” refers to a service entity that provides the services of distributing multimedia content to the user based on authenticity of marketing data acquired from the user and/or one or more marketing databases, confirming that the user has viewed the multimedia content, and compensating the user for viewing the multimedia content. One or more multimedia content owners upload multimedia content on the multimedia distribution platform and/or provide a reference to the location of the multimedia content. As used herein, the term “multimedia content owner” refers to an entity that generates the multimedia content. In an embodiment, the user creates a user account on the multimedia distribution platform. The user may opt in to receive the multimedia content during the creation of the user account.

The multimedia distribution platform acquires 102 marketing data from the user via the interactive interface. As used herein, the term “marketing data” refers to selected population characteristics as used in marketing research, opinion research, etc. The marketing data is, for example, race, age, income, disabilities, mobility in terms of travel time to work or number of vehicles available, type of car, vacation preferences, educational attainment, home ownership, employment status, geographical location, etc. The marketing data comprises, for example, demographic data, psychographic data, and behavioral data. The demographic data comprises, for example, age, sex, income, product preferences, language preferences, etc. The psychographic data comprises, for example, personality attitudes, desires, interests, lifestyles, activities, opinions, etc. The behavioral data comprises, for example, user activities such as purchase actions, clicking on coupons, web activities, etc. The behavioral data is based on actual observed user actions such as clicking on specific offers, purchase and browsing patterns, etc.

The multimedia distribution platform determines 103 authenticity of the user's acquired marketing data. As used herein, “determining authenticity” refers to determining credibility, reliability, accuracy, etc., of the acquired marketing data. The multimedia distribution platform determines the authenticity of the user's acquired marketing data, for example, by presenting 103a one or more marketing specific challenges to the user on the interactive interface based on the acquired marketing data, obtaining 103b one or more responses to the marketing specific challenges from the user via the interactive interface, and analyzing 103c the obtained responses using one or more marketing databases to determine the authenticity of the user's acquired marketing data. As used herein, the term “marketing databases” refers to, for example, external and commercially available databases and other third party databases that store marketing data such as commercial and non-commercial information that permits inferences of a user's marketing profile through pre-existing user, demographic, location, psychographic or behavioral data, interests, activities, opinions, etc. The marketing databases compile and sell consumer or marketing data, for example, credit card purchases, supermarket scans, credit ratings, job information, home information, census data, education information, etc. to the multimedia distribution platform for targeting of multimedia content. The multimedia distribution platform compares the responses obtained from the user with marketing data, for example, average income levels for different zip codes, voting patterns, house values, ethnicity, education, credit reports, marriage records, etc. from the marketing databases to determine authenticity of the acquired marketing data of the user.

The multimedia distribution platform analyzes the responses obtained from the user to provide feedback to multimedia content owners, for example, advertisers. For example, on analyzing responses and comparing the acquired marketing data with the marketing data from the marketing databases, the multimedia distribution platform may determine that women are more authentic about their purchase intent for clothing than men are. In another example, the multimedia distribution platform may determine that persons over the age of thirty are more authentic about their income levels. The multimedia distribution platform performs a multivariate analysis that can be used as a feedback mechanism to determine what questions are more likely to be answered authentically.

The multimedia distribution platform rates 104 the acquired marketing data of the user based on the determined authenticity. The multimedia distribution platform targets 105 the multimedia content to the user based on the determined authenticity and/or the rating of the acquired marketing data of the user. As used herein, “rating” also referred to as a “reliability rating” refers to a score used to determine a level of reliability, credibility, and/or accuracy of the user's marketing data. The multimedia distribution platform narrows down the users selected to receive the multimedia content based on the determined authenticity of the acquired marketing data.

The multimedia distribution platform identifies and rectifies inconsistencies in the acquired marketing data of the user, for example, using one or more marketing databases. The multimedia distribution platform identifies the inconsistencies in the acquired marketing data of the user, for example, by presenting one or more additional marketing specific challenges to the user on the interactive interface. On determining inconsistencies in the acquired marketing data of the user, the multimedia distribution platform examines the acquired marketing data and queries the marketing databases to present additional marketing specific challenges to the user to rectify the inconsistencies.

The multimedia distribution platform varies the rating of the acquired marketing data of the user based on inconsistencies in the acquired marketing data of the user, the marketing specific challenges, time, purchase information, etc. The rating may vary on account of the user, time, question type, product type, etc. The multimedia distribution platform utilizes the acquired marketing data, the marketing databases, the rating, etc. for generating additional marketing specific challenges to determine the authenticity of the acquired marketing data of the user.

Consider an example where a user Mark logs in to the multimedia distribution platform and answers direct questions presented by the multimedia distribution platform, indicating that he owns a home in the suburbs of New Jersey, is married, has three children, and has Verizon of Verizon Communications Inc. as his cable television provider. The marketing data, for example, credit reports, purchase behavior, and address information, in the marketing databases indicates that Mark is single, lives in an apartment in Brooklyn, and has no purchase history with Verizon. In this case, Mark's self-answered data would be given a low reliability rating and the targeting of advertisements is heavily weighted towards the data in the marketing databases. Due to the inconsistencies in Mark's responses, the multimedia distribution platform triggers more specific challenge questions, for example, “How long have you been married?” for Mark to rectify inconsistencies of the acquired marketing data with the marketing data in the marketing databases. If Mark responds to the question by entering “two years”, the multimedia distribution platform may then infer that the marketing databases lack information on Mark's present marital situation. In this case, the marketing data acquired from Mark is given a higher reliability rating and the targeting of the multimedia content may be weighted towards the marketing data acquired from Mark. The reliability rating may vary with time on account of changes in the user's marketing data. The acquired marketing data is required to be consistent to obtain a high reliability rating.

Consider another example where a user logs on to the multimedia distribution platform via the internet. The multimedia distribution platform prompts the user to enter marketing data, for example, “name”, “location”, “marital status”, “mobile phone number”, etc. The user responds to the prompt by providing “David” as “name”, “New York” as the location, “married” as the marital status, and “716-000-000” as a specific user mobile number. The multimedia distribution platform uses data from a marketing database comprising a list of inhabitants of New York to determine the authenticity of the marketing data entered by the user. The multimedia distribution platform obtains a match as “David” tagged with “New York”, “Unmarried”, and “716-000-000” as a specific user mobile number in the marketing database and provides a low reliability rating to the marketing data entered by the user, as the match obtained is not exact. The multimedia distribution platform concludes that the acquired marketing data provided by the user is not authentic. In this case, the acquired marketing data is given a low reliability rating and the targeting of the multimedia content is heavily weighted towards the data in the marketing database. The multimedia distribution platform obtains data pertaining to “David” tagged with “New York” and “Unmarried” from the marketing database. The obtained data comprises “age” as “28”. The multimedia distribution platform targets a video suitable for users located in “New York”, with a marital status “Unmarried”, of age group “20-30 years”, to the user.

The multimedia distribution platform may also put forth a question “How long have you been married?” to rectify inconsistencies of the acquired marketing data with the data in the marketing database. The user responds to the question by entering “two years”. The multimedia distribution platform may then infer that the marketing database lacks information on the user's present marital situation. In this case, the acquired marketing data from the user is given a higher reliability rating and the targeting of the multimedia content is heavily weighted towards the acquired marketing data from the user. The multimedia distribution platform obtains data pertaining to “David” tagged with “New York” and “Married” from the marketing database. The obtained data comprises “age” as “28”. The multimedia distribution platform targets a video suitable for users located in “New York”, with a marital status “Married”, of age group “20-30 years”, to the user.

Furthermore, at a later time, the same user David may be presented with marketing specific challenges with respect to his education and income. If the user provides responses that are consistent with the data in the marketing databases, the user's response for education and income is rated high while the user's response for the marital status information is rated low. In this embodiment, the marketing databases augment and adjust the marketing profile obtained from the user to provide the best authenticated profile, irrespective of whether the marketing data is obtained directly from the user or from third party sources or external marketing databases.

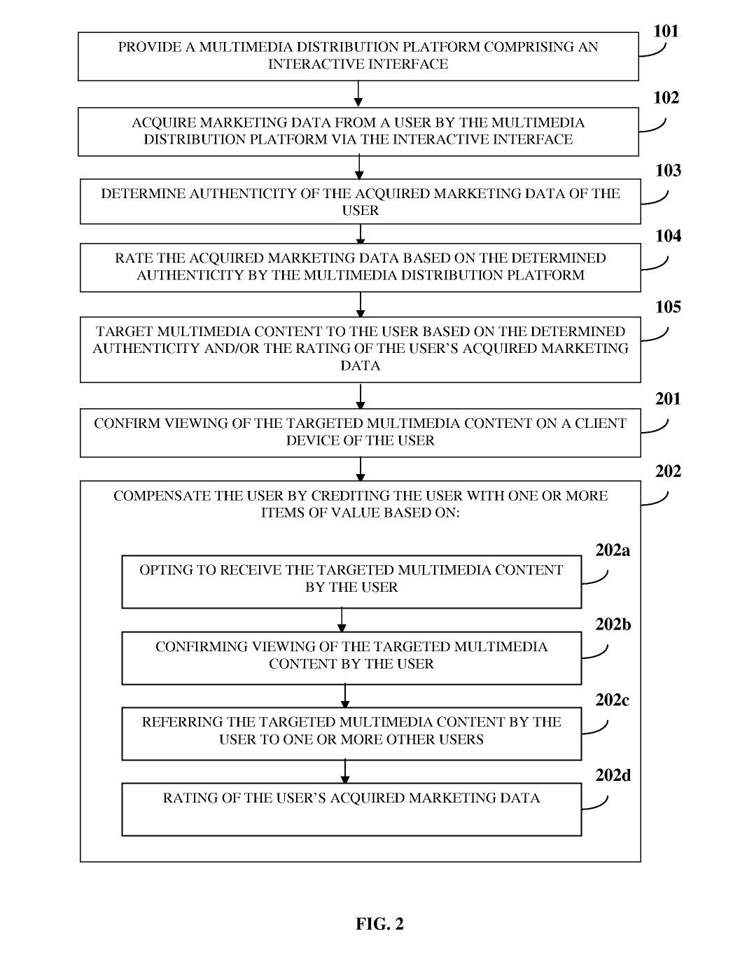

FIG. 2 illustrates a computer implemented method for targeting multimedia content based on authenticity of marketing data of a user and compensating the user based on viewing of the targeted multimedia content. The computer implemented method disclosed herein provides 101 a multimedia distribution platform comprising an interactive interface to the user. The multimedia distribution platform acquires 102 marketing data from the user via the interactive interface, determines 103 authenticity of the acquired marketing data, rates 104 the acquired marketing data based on the determined authenticity, and targets 105 the multimedia content to the user based on the determined authenticity and/or the rating of the acquired marketing data as disclosed in the detailed description of FIG. 1. The multimedia distribution platform targets the multimedia content to the user, for example, based on the preferences selected by the user, the acquired marketing data of the user, the determined authenticity, the rating of the acquired marketing data of the user, external marketing data obtained from one or more marketing databases, etc.

The user receives the targeted multimedia content from the multimedia distribution platform and plays the received multimedia content on a display screen of a client device of the user. As used herein, the term “client device” refers to, for example, an internet-enabled mobile device, a tablet computer, a computer with a web browser, and a set top box capable of delivering interactive multimedia content, an internet protocol enabled device on an internet connection, etc. The client device is capable of receiving the targeted multimedia content in different multimedia content formats, for example, hypertext markup language 5 (HTML5) format, the Windows® audio video format and other proprietary and non-proprietary formats. The client device receives the targeted multimedia content, for example, an advertisement, a commercial message, an educational clip, an entertainment clip, etc. from the media service provider via the multimedia distribution platform, and plays the multimedia content on the display screen of the user's client device, for example, in an audiovisual format.

In an embodiment, the multimedia distribution platform streams the multimedia content to the client device using a network protocol that supports streaming media. The network protocol comprises, for example, a user datagram protocol, a real time streaming protocol, a real time transport protocol, and a real time transport control protocol. These network protocols are used for controlling streaming media sessions between the multimedia distribution platform and the client device. Moreover, the streaming multimedia content is delivered to the client device via different modes of transmission, for example, unicast, multicast, or peer to peer transmissions. In another embodiment, the multimedia content is received by the client device from the multimedia distribution platform as a progressive download. In an embodiment, the multimedia content may be cached in segments on an intermediate system, for example, a “store and forward” system, the details of which are disclosed in the co-pending application Ser. No. 12/822,526, which is incorporated herein by reference in its entirety.

In an embodiment, the multimedia distribution platform confirms 201 viewing of the targeted multimedia content on the client device of the user. The multimedia distribution platform confirms viewing of the targeted multimedia content by the user using a random challenge that is, for example, random in content, presented at random times during and/or after play of the targeted multimedia content, and presented at random physical locations on the targeted multimedia content. The random challenge comprises, for example, one or more of a random number, a random icon, a random shape, a product logo, a service logo, a random color, a random mathematical equation, a random target on the display screen of the client device, etc. for the user to interact therewith using touch or a pointing device.

In an embodiment, the random challenge is generated and presented to the user by overlaying the generated random challenge on the targeted multimedia content. The random challenge is overlaid at different positions on the multimedia content. The random challenge is overlaid using technologies, for example, hypertext markup language 5 (HTML5), Adobe® Flash or other video creation standards. In another embodiment, the generated random challenge is presented to the user by interrupting the play of the targeted multimedia content after an interrupt time period and inserting the generated random challenge. The interrupt time period is less than the duration of the multimedia content. The details of multimedia content view confirmation are disclosed in the co-pending application Ser. No. 12/544,233 and the co-pending application Ser. No. 12/822,526, which are incorporated herein by reference in their entirety.

A response is invoked from the user for the presented random challenge, and a response report is generated based on the response from the user. The response determines whether the user has viewed the targeted multimedia content. A correct response to the random challenge such as a random number, a random icon, a random shape, a product logo, a service logo, a random color, a random mathematical equation, a random target on the display screen of the client device, etc. from the user comprises, for example, entering the number, selection of an option representing the icon from an options list, a selection of an option representing a geometrical shape from an options list, selection of an option representing the product logo or a service logo from an options list, selection of an option representing a color from an options list, entering the result of the mathematical equation into the client device, selection or interaction with a target on a touch screen, etc. respectively.

The streams comprising the random challenge and the multimedia content are either integrated at the server level or combined at a web browser on the client device of the user. The random challenge and the multimedia content may arrive at the client device of the user as a single integrated stream or as two independent streams that are combined in real time at the client device.

In another embodiment, the multimedia distribution platform compensates 202 the user by crediting the user with one or more items of value based on the viewing of the targeted multimedia content and/or the rating of the acquired marketing data of the user. The items of value comprise, for example, one or more of points, points redeemable for cash, points redeemable for additional items of value, scores, scores redeemable for cash, scores redeemable for additional items of value, cash, discounts, access to premium multimedia content, units of virtual currency, cash payment, bill credit, coupons, special discounts on products or services, access to desired multimedia content from the multimedia distribution platform, and any combination thereof.

The compensation of the user is, for example, based on the user opting 202a to receive the targeted multimedia content from the multimedia distribution platform, the user confirming 202b the viewing of the targeted multimedia content, the user referring 202c the targeted multimedia content to one or more other users, and the rating 202d of the acquired marketing data of the user. The details of compensating a user based on referrals of multimedia content in a virtual community network are disclosed in the co-pending application Ser. No. 12/829,636, which is incorporated herein by reference in its entirety. The multimedia distribution platform determines the number of items of value to be credited to the user based on the rating of the acquired marketing data of the user. In an embodiment, the multimedia distribution platform presents a commercial transaction opportunity for the user for enabling the user to purchase one or more products and services using the credited items of value.

Consider an example where a user logs on to the multimedia distribution platform using the internet. The user creates a user account on the multimedia distribution platform. The user opts in to receive the multimedia content during creation of the user account. The multimedia distribution platform prompts the user to enter a location, age, and a favorite gadget. The user responds to the prompt by providing “Yorkshire” for the location, “34” for the age, and “iPod” for the favorite gadget. The multimedia distribution platform acquires the marketing data from the responses provided by the user. The multimedia distribution platform prompts the user to enter the exact address of the user. The user responds to the prompt by entering “#24, Otley Street, BD231”. The multimedia distribution platform analyzes and verifies the response provided by the user along with the acquired marketing data using a marketing database comprising the street addresses within “Yorkshire” and the pin codes. The multimedia distribution platform determines that the response provided by the user and the acquired marketing data is consistent with the data in the marketing database. The multimedia distribution platform provides a high reliability rating to the acquired marketing data of the user. The multimedia distribution platform tags the acquired marketing data of the user as “highly reliable”.

The multimedia distribution platform targets a video of the iPod® of Apple Inc. tagged with age “20-40 years”, suitable for the user belonging to the location “Yorkshire”. The user receives the Apple® iPod® video and plays the received video on a personal computer. During playing of the received Apple® iPod® video, a random challenge, for example, a mathematical equation based challenge, comprising a random equation (3+4=?) or random numbers such as “6” and “2” is presented to the user. When the video ends, the user is presented with an opportunity to submit a solution to the mathematical equation with a message, for example, “What is the sum of the numbers shown during the video?”. The user answers the question accurately and the multimedia distribution platform confirms viewing of the video. The multimedia distribution platform compensates the user by crediting the created user account with 4000 points on confirming that the user has viewed the targeted multimedia content. The multimedia distribution platform presents a product purchase offer to buy an Apple® iPod® at a 10% discount, final price $79 or 4000 points, to the user. The user decides to purchase the Apple® iPod® and transfers 4000 points from the created user account and purchases the Apple® iPod®.

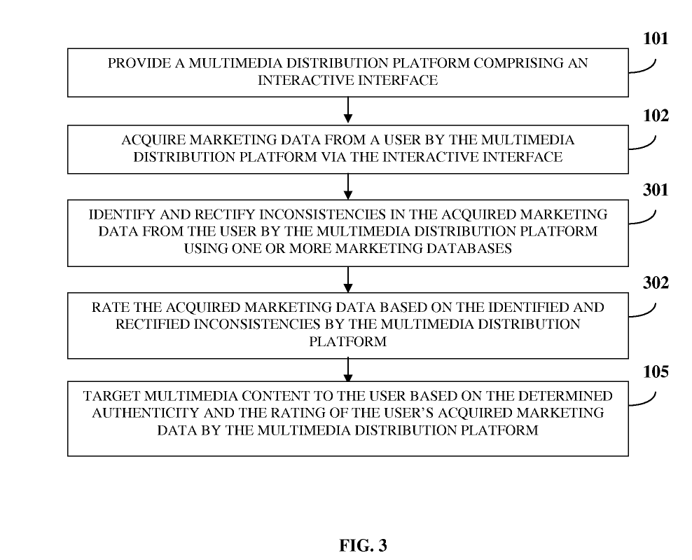

FIG. 3 illustrates an embodiment of the computer implemented method for targeting multimedia content based on authenticity of marketing data of a user. The computer implemented method disclosed herein provides 101 a multimedia distribution platform comprising an interactive interface to the user. The multimedia distribution platform acquires 102 marketing data from the user via the interactive interface. The multimedia distribution platform identifies and rectifies 301 inconsistencies in the acquired marketing data from the user using one or more marketing databases. The multimedia distribution platform rectifies inconsistencies based on analysis of the obtained responses to the marketing specific challenges presented to the user, using the marketing databases to determine authenticity of the acquired marketing data of the user.

The multimedia distribution platform rates 302 the acquired marketing data of the user based on the identified and rectified inconsistencies. The multimedia distribution platform provides a reliability rating for the user based on the analysis of the acquired marketing data. If the obtained responses are consistent with the data in the marketing databases, the multimedia distribution platform provides a high reliability rating to the acquired marketing data. If the obtained responses are inconsistent with the data in the marketing databases, the multimedia distribution platform may present additional marketing specific challenges to the user. The multimedia distribution platform rectifies inconsistencies in the obtained responses by successively presenting additional marketing specific challenges to the user.

If the obtained responses from the user to even the subsequent marketing specific challenges remain inconsistent with the data in the marketing databases, the multimedia distribution platform provides a low reliability rating to the acquired marketing data of the user. If the obtained responses appear to be more consistent in the subsequent marketing specific challenges, the multimedia distribution platform provides a moderate reliability rating to the acquired marketing data of the user. If the reliability rating is low, the multimedia distribution platform rates the acquired marketing data by tagging the marketing data acquired from the user as “unreliable”. If the reliability rating is moderate, the multimedia distribution platform rates the acquired marketing data by tagging the acquired marketing data as “moderately reliable”. If the reliability rating is high, the multimedia distribution platform rates the acquired marketing data by tagging the acquired marketing data of the user as “highly reliable”. In an example, the multimedia distribution platform targets multimedia content to the users that have marketing data rated as “highly reliable” and “moderately reliable”.

The multimedia distribution platform provides a low reliability rating if the acquired marketing data is not authentic or provides a high reliability rating if the acquired marketing data is authentic. A low reliability rating is not inherently good or bad from an economic viewpoint. The use of the marketing databases enables determination of the reliability rating for the self-supplied responses of the user. Users with a high reliability rating, as verified by the marketing databases become the most valuable users for targeting advertising. As the reliability rating diminishes due to inconsistencies between self-supplied data and the third party data from the marketing databases, specific challenge questions are inserted to the users' question queue that aid in verifying the users' answers or further casts doubt. The enhancement of user supplied marketing data with third party data increases the credibility of the marketing data and provides a more accurate and verifiable targeting system. The marketing databases augment and adjust the acquired marketing data of the user to maintain accurate marketing data of the user and provide relevant marketing specific challenges to the user irrespective of whether the marketing data is supplied by the user or whether the multimedia distribution platform accesses the marketing data from the marketing databases.

The multimedia distribution platform targets 105 the multimedia content to the user based on the rating of the acquired marketing data of the user. If the reliability rating is low, the multimedia distribution platform targets the multimedia content based on the data pertaining to the user, from the marketing database. If the reliability rating is high, the multimedia distribution platform targets the multimedia content based on the acquired marketing data from the user. In an embodiment, the multimedia distribution platform provides recommendations to the user for improving the rating of the acquired marketing data of the user. The user receives the targeted multimedia content from the multimedia distribution platform on a display screen of a client device of the user. The user plays and views the received multimedia content or stores the received multimedia content for later viewing. Multimedia content owners may use the reliability ratings to target multimedia content. For example, an owner of a health club logs into the multimedia distribution platform to target multimedia content to users with low reliability rating of their exercise related marketing data.

The multimedia distribution platform confirms viewing of the targeting multimedia content and compensates the user. The details of compensating the user are disclosed in the co-pending application Ser. No. 12/822,526 and the co-pending application Ser. No. 12/829,636, which are incorporated herein by reference in their entirety. In an embodiment, the compensation is a form of a redeemable credit score accumulated by the user over time. The credit score is redeemed, for example, with money, gifts, or any other item of value. The multimedia distribution platform compensates the user by depositing, for example, a predetermined amount of money in the user account of the user for a confirmed viewing of the targeted multimedia content. The multimedia distribution platform compensates the user with increased items of value if the multimedia distribution platform has rated the acquired marketing data of the user as “high”. The multimedia distribution platform compensates the user with decreased items of value if the multimedia distribution platform has rated the marketing data of the user as “low”. In an embodiment, the multimedia distribution platform provides the user with an electronic wallet associated with the user account created on the multimedia distribution platform for accruing the credited items of value over a period of time.

Furthermore, the multimedia distribution platform allows the user to add creative content to the targeted multimedia content. The multimedia distribution platform redirects the multimedia content with the added creative content to the owners of the multimedia content. The user is compensated with another item of value on receiving approval of the added creative content.

The multimedia distribution platform presents the user with a commercial transaction opportunity for enabling purchasing of products and/or services by the user using the credited items of value accrued in the electronic wallet associated with the user account of the user. In an embodiment, the presented commercial transaction opportunity for the user enables purchasing of a product or a service that is not associated with the targeted multimedia content.

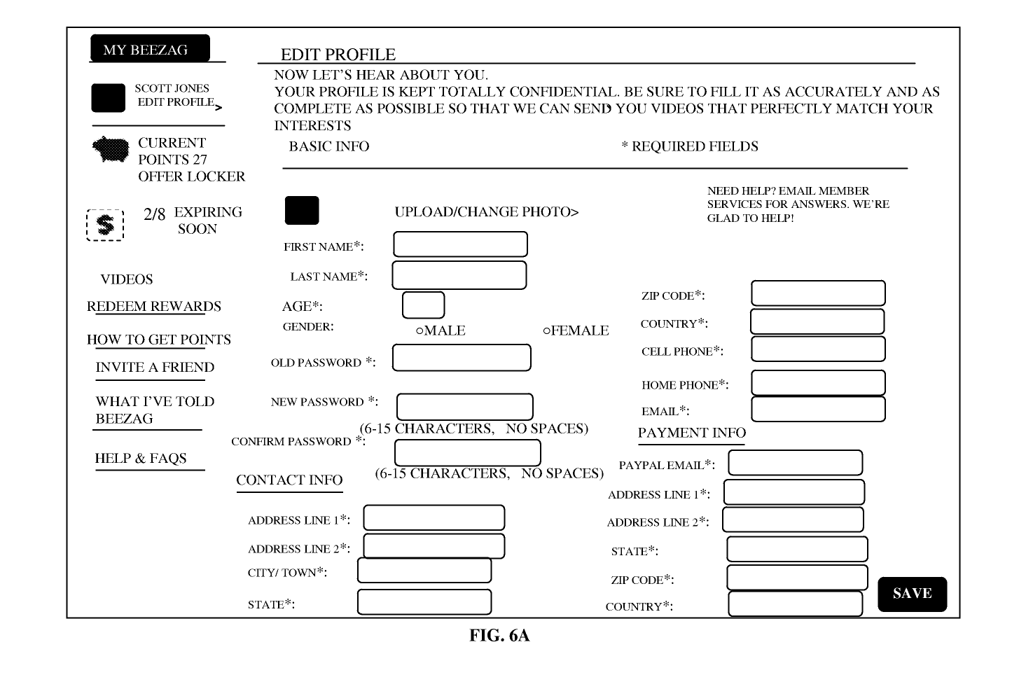

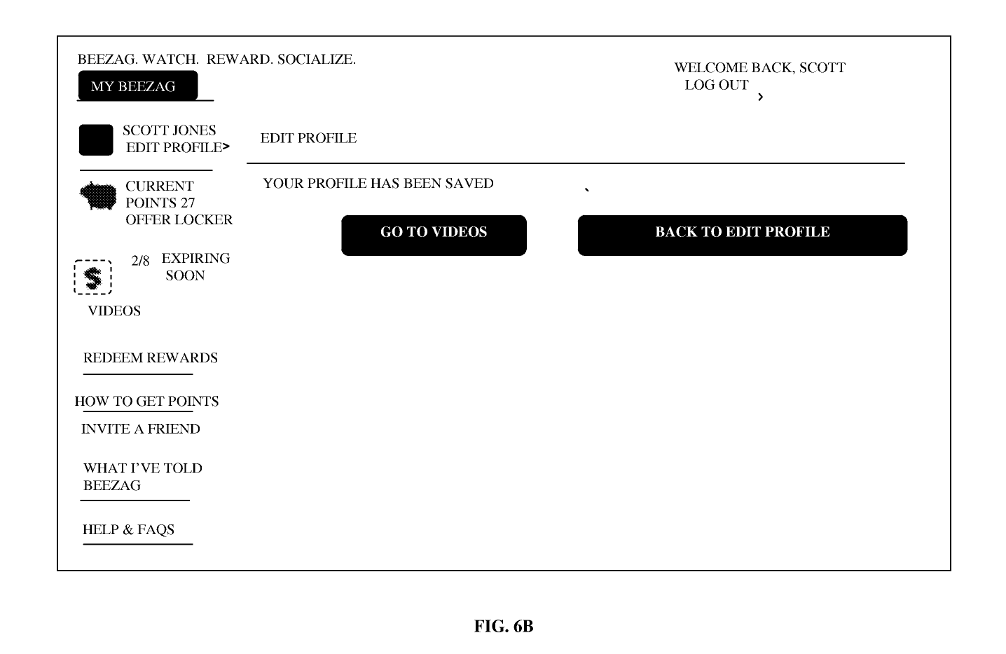

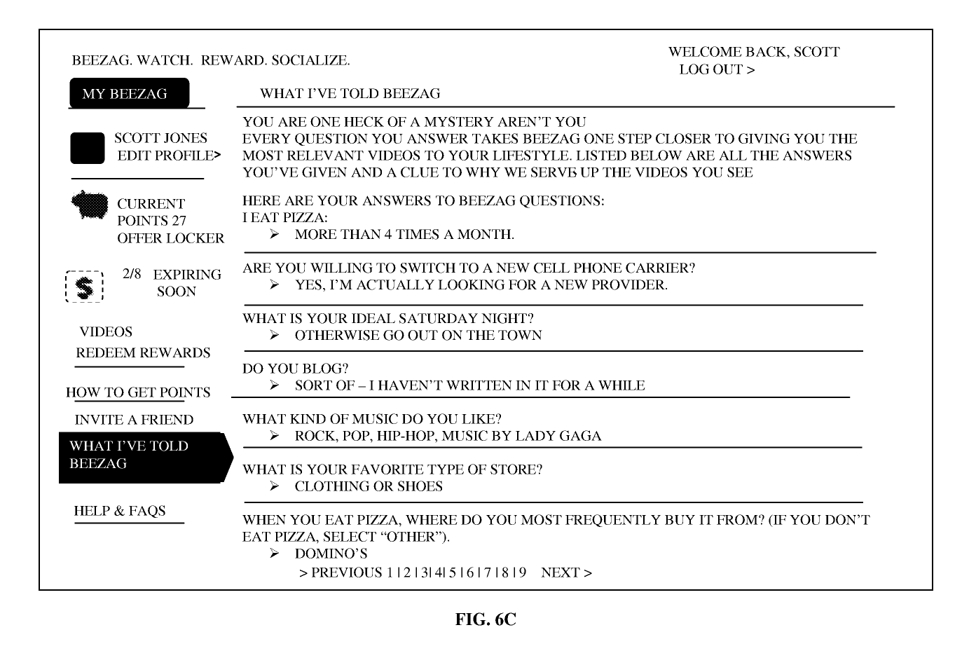

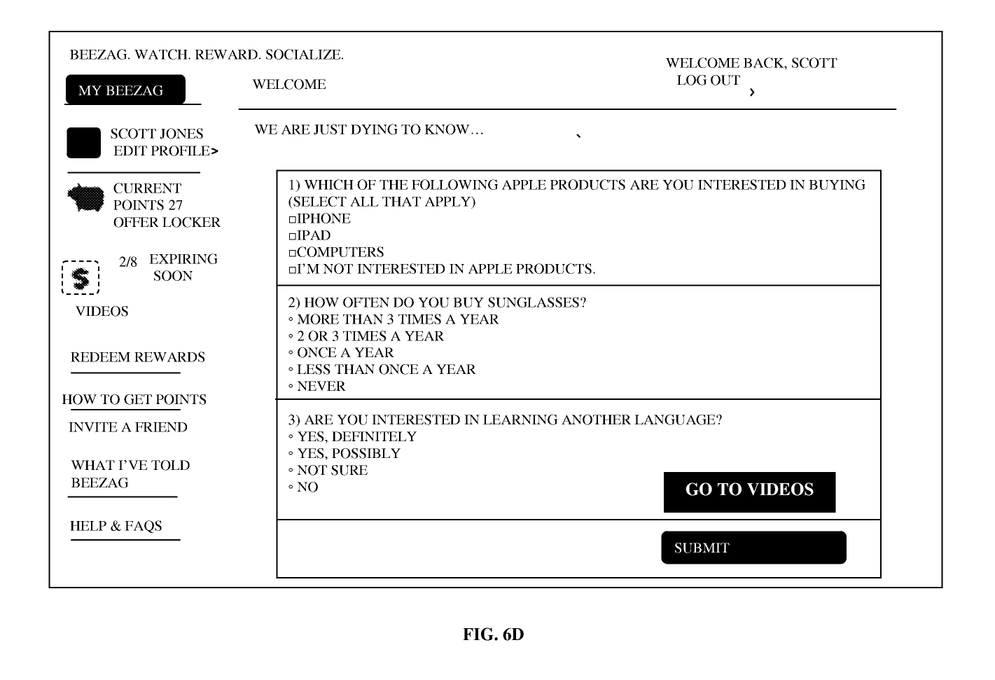

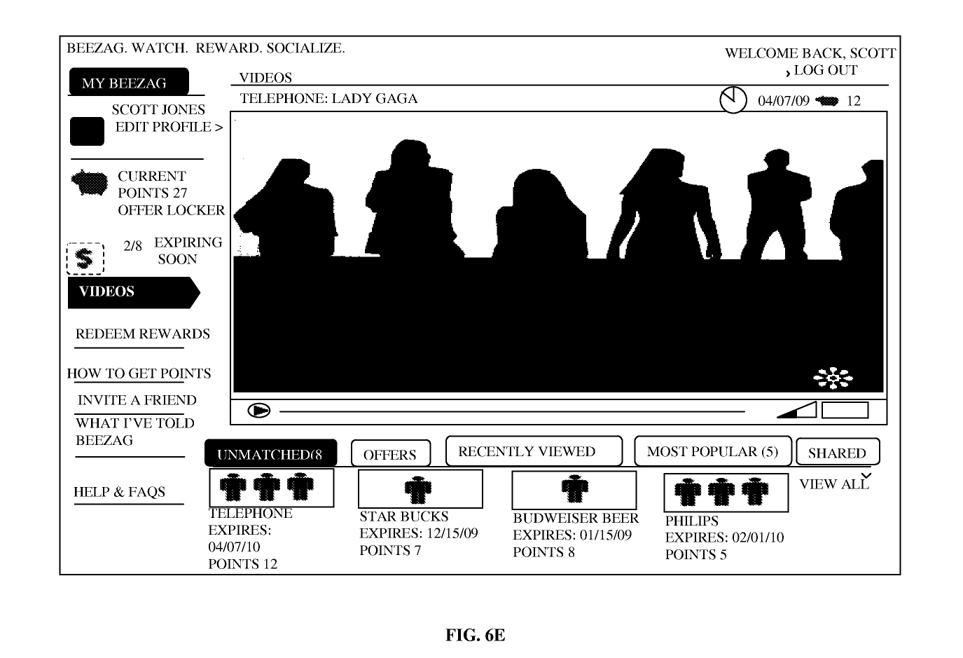

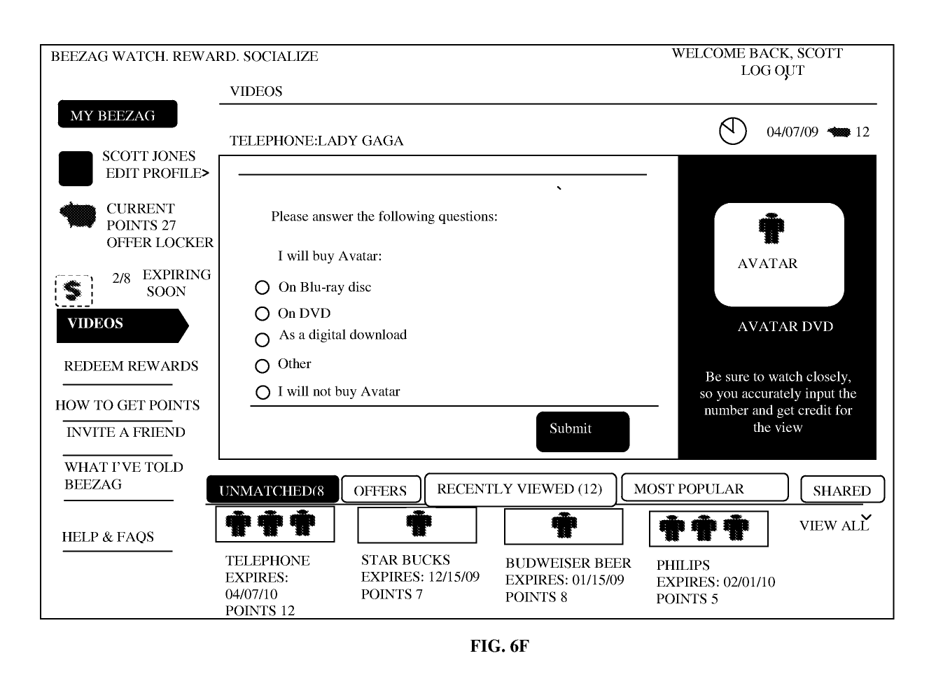

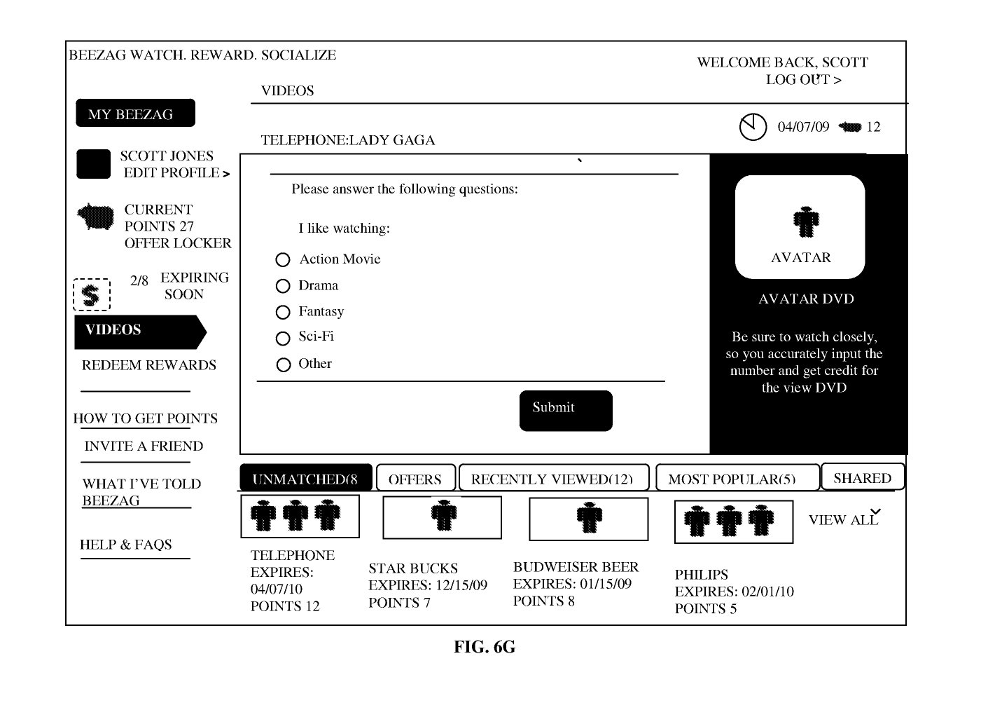

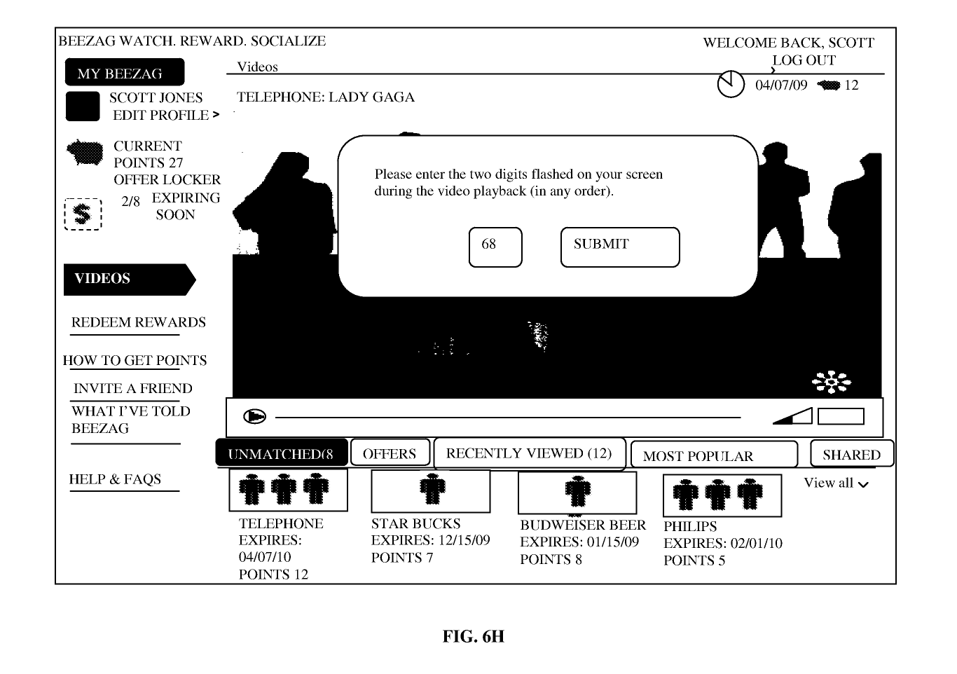

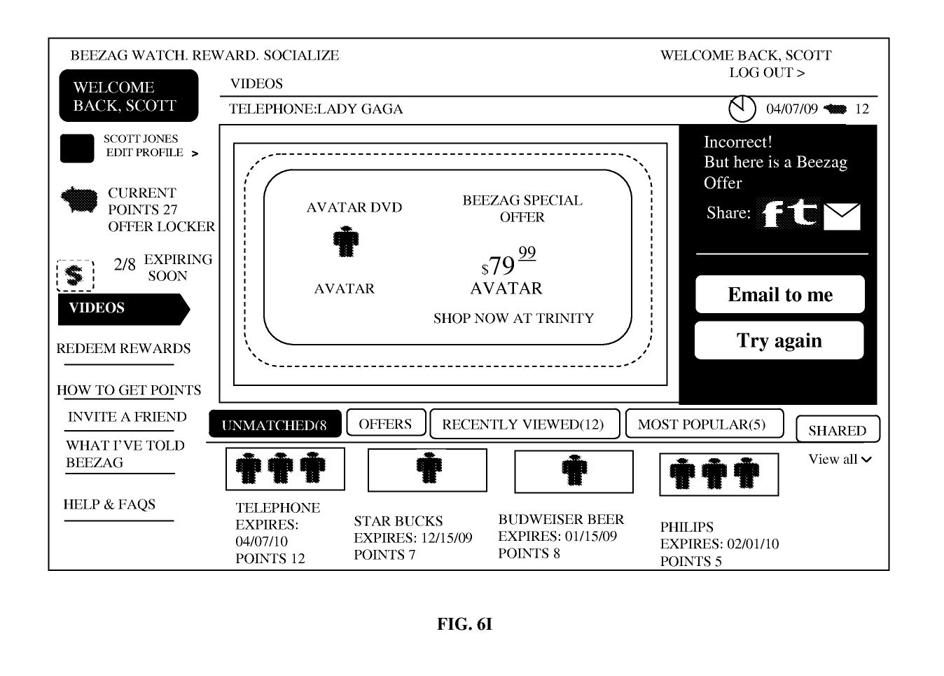

In an embodiment, the user is directed to a commercial transaction platform by the multimedia distribution platform on confirming that the user has viewed the targeted multimedia content. The commercial transaction platform is, for example, a commercial website, a coupon or offer website, etc. In an embodiment, the user is directed to the commercial transaction platform by an interactive promotional segment, for example, a clickable coupon, inserted within the targeted multimedia content as exemplarily illustrated in FIG. 6I. The interactive promotional segment directs the user to the commercial transaction platform for enabling the user to purchase products, for example, digital versatile discs (DVDs) and services on the commercial transaction platform. The user accesses the commercial transaction platform and uses the accrued items of value in the electronic wallet associated with the user account for purchasing the products and/or the services on the commercial transaction platform. The user purchases products and services on the commercial transaction platform by redeeming the accrued items of value from the electronic wallet associated with the user account. In another embodiment, the clickable coupon used to direct the user to the commercial transaction platform is redeemed for special discounts on the purchased products and services.

The multimedia distribution platform varies the rating of the acquired marketing data of the user over a period of time. The multimedia distribution platform can also vary the rating of the acquired marketing data, based on specific categories, for example, age, sex, income, occupation, etc. The multimedia distribution platform can also vary the rating of the acquired marketing data between marketing specific challenges, for example, between marketing surveys. The rating of the acquired marketing data of the user is dynamic. The determination of the authenticity of the acquired marketing data of the user is, for example, an instantaneous determination, a futuristic determination, etc.

In an embodiment, if the obtained responses from the user for the marketing specific challenges, for example, survey questions, are incorrect or inconsistent as analyzed by the multimedia distribution platform using the marketing databases, the multimedia distribution platform targets the multimedia content to the user based on marketing data from a more accurate marketing database and not based on the obtained responses from the user. The multimedia distribution platform may query the marketing database at the instant of the survey question to determine authenticity, and may then direct a specific future question, or the multimedia distribution platform may query the marketing database in the future to determine if a forecasted future event such as a purchase did intend to happen.

In an embodiment, the multimedia distribution platform provides for a self learning system. The acquired marketing data combined with the data accessed by the multimedia distribution platform from the marketing database yields results regarding the authenticity of the user's acquired marketing data. The multimedia distribution platform intelligently learns to generate relevant marketing specific challenges that are presented to the user for targeting relevant multimedia content. The multimedia distribution platform functions as a self adjusting and self-learning marketing survey engine.

In another embodiment, the user provides one or more responses to the marketing specific challenges, for example, regarding a product that the user intends to buy. The multimedia distribution platform presents the user with a marketing specific challenge, for example, “Do you want to buy product XXXX?”. The multimedia distribution platform compares the responses to, for example, actual purchasing history of the product by the user from the marketing databases. The multimedia distribution platform uses the comparison to rate the marketing data regarding the purchasing history of the user. If the multimedia distribution platform determines that the user actually made a purchase of the product within a specific period of time, the user gets a higher reliability rating. In this embodiment, the multimedia distribution platform does not rate the acquired marketing data in real time, but triggers a future marketing database query to determine if the event forecasted by the responses of the user actually happened.

Consider an example where a user interacts with the multimedia distribution platform from a user's client device such as a mobile device equipped with location based service technology. In this example, the user is asked three marketing questions including the user's present location. If the user's response to the user's present location question is not consistent with the user's location provided by a location based technology marketing database, then the user's location provided by the location based technology marketing database is used for targeting the user with multimedia content such as advertisements, thereby giving the user's present location from the user's response a low reliability rating. If the user engages in another session with the multimedia distribution platform after lapse of a period of time such as one week later, and answers the present location marketing question correctly, then the user's reliability rating on present location from the user's response is increased. The user has an aggregate reliability rating that is a combination of the calculated ratings based on authenticity of all their answers over time.

In an embodiment, the multimedia distribution platform rates the acquired marketing data of the user by maintaining a relative reliability rating for the acquired marketing data. In this embodiment, the multimedia distribution platform increases the relative reliability rating for every correct response provided by the user and decreases the relative reliability rating for every incorrect response provided by the user for the marketing specific challenges. The multimedia distribution platform provides the relative reliability rating per session of the user with the multimedia distribution platform and aggregates the relative reliability rating across a specific number of sessions. The multimedia distribution platform determines whether the relative reliability rating increases, decreases, or remains the same over time.

In an embodiment, rating of data in the marketing databases can be used to determine the likelihood of a specific question type being answered authentically. For example, if a group of users is asked about their income level and the multimedia distribution platform determines that a large percentage answer in an unauthentic manner, while when asked about education they answer correctly, the multimedia distribution platform provides feedback to multimedia content owners, for example, marketers, advertisers, etc. on which questions are more often answered correctly versus those that are often answered incorrectly. In another example, the multimedia distribution platform presents the user with marketing specific challenges on product types to provide feedback to multimedia content owners on whether certain product types elicit more accurate and reliable responses. In another example, the multimedia distribution platform provides feedback to multimedia content owners on whether certain demographic groups elicit more accurate and reliable responses and are therefore more authentic.

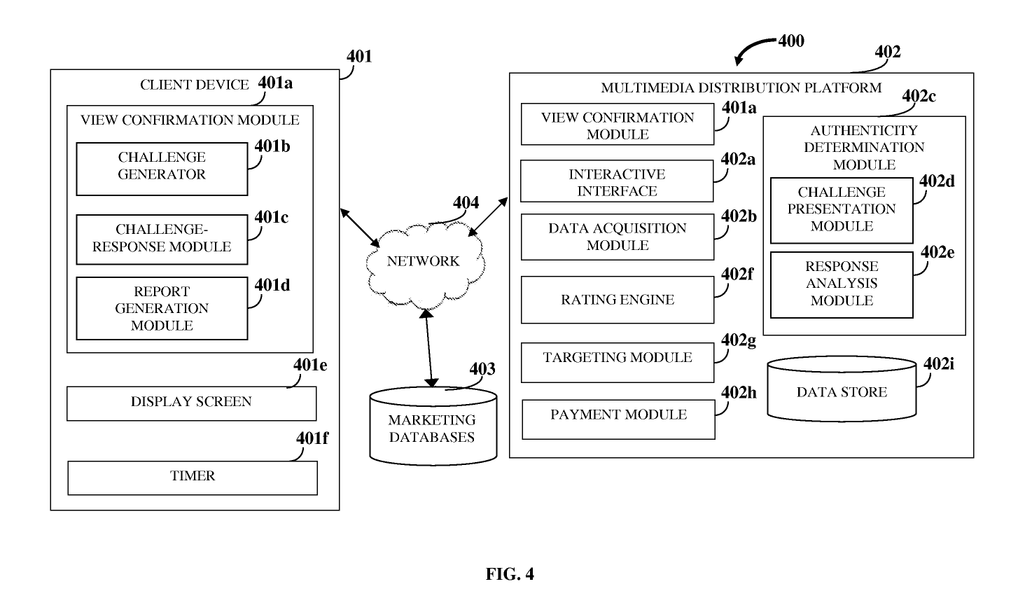

FIG. 4 illustrates a computer implemented system 400 for targeting multimedia content based on authenticity of marketing data of a user. The computer implemented system 400 disclosed herein comprises a client device 401, a multimedia distribution platform 402, and marketing databases 403 connected via a network 404. The client device 401 comprises a display screen 401e and a timer 401f. The client device 401 is connected to the multimedia distribution platform 402 via the network 404. In an embodiment, the multimedia distribution platform 402 is hosted on a server. The multimedia distribution platform 402 comprises an interactive interface 402a, a data acquisition module 402b, an authenticity determination module 402c, a rating engine 402f, a targeting module 402g, a payment module 402h, and a data store 402i. The multimedia distribution platform 402 provides the interactive interface 402a to the user for acquiring the marketing data from the user, presenting marketing specific challenges, and for obtaining responses to the marketing specific challenges from the user.

The data acquisition module 402b acquires marketing data from the user via the interactive interface 402a. The authenticity determination module 402c determines authenticity of the acquired marketing data of the user. The authenticity determination module 402c comprises a challenge presentation module 402d and a response analysis module 402e. The challenge presentation module 402d generates and presents one or more marketing specific challenges to the user on the interactive interface 402a based on the acquired marketing data. The response analysis module 402e obtains one or more responses to the presented marketing specific challenges from the user via the interactive interface 402a. The response analysis module 402e analyzes the obtained responses using the marketing databases 403 to determine the authenticity of the acquired marketing data of the user. The authenticity determination module 402c also identifies and rectifies inconsistencies in the acquired marketing data of the user using the marketing databases 403. The challenge presentation module 402d utilizes the acquired marketing data, the marketing databases 403, and the rating of the acquired marketing data of the user for generating additional marketing specific challenges to determine authenticity of the acquired marketing data of the user.

The rating engine 402f rates the acquired marketing data of the user based on the determined authenticity of the acquired marketing data. The rating engine 402f varies the rating of the acquired marketing data of the user based on inconsistencies in the acquired marketing data of the user, the marketing specific challenges, time, purchase information, etc. In an embodiment, the rating engine 402f provides recommendations to the user for improving the rating of the acquired marketing data of the user. The targeting module 402g targets the multimedia content to the user based on, for example, the acquired marketing data of the user, the determined authenticity, the rating of the acquired marketing data of the user, external marketing data obtained from one or more marketing databases 403, etc. The client device 401 receives the targeted multimedia content from the multimedia distribution platform 402 and plays the targeted multimedia content on the display screen 401e of the client device 401.

In an embodiment, the computer implemented system 400 disclosed herein further comprises a view confirmation module 401a provided on the client device 401 and/or the multimedia distribution platform 402. The view confirmation module 401a confirms viewing of the targeted multimedia content by the user. The view confirmation module 401a comprises a challenge generator 401b, a challenge-response module 401c, and a report generation module 401d. The challenge generator 401b generates a random challenge that is one or more of random in content, for example, numbers, letters, shapes, phrases, etc. from a predefined set, presented at random times during and/or after play of the targeted multimedia content, and presented at random physical locations on the targeted multimedia content. In an embodiment, the random challenge content is optionally unrelated to the multimedia content.

The challenge-response module 401c presents the generated random challenge to the user on the display screen 401e of the client device 401. In an embodiment, the challenge-response module 401c presents the generated random challenge to the user on the display screen 401e of the client device 401 by overlaying the generated random challenge on the targeted multimedia content. In another embodiment, the challenge-response module 401c presents the generated random challenge to the user on the display screen 401e of the client device 401 by interrupting the play of the targeted multimedia content and inserting the generated random challenge in and/or around the targeted multimedia content. The timer 401f on the client device 401 counts an interrupt time period for interrupting the playing of the multimedia content and presenting the generated random challenge, wherein the interrupt time period is less than duration of the multimedia content. The challenge-response module 401c presents one or more random challenges at one or more times during and/or after the multimedia content is played.

The challenge-response module 401c invokes a response from the user for the presented random challenge. The user enters the response using an input device on the client device 401. The timer 401f ensures that the user provides the response to the random challenge within a predetermined period of time after the random challenge is presented. The challenge-response module 401c determines whether the user has entered a response for the presented random challenge to confirm that the user viewed the targeted multimedia content. The challenge-response module 401c determines whether the response entered by the user for the presented random challenge is correct to confirm that the user viewed the targeted multimedia content. In an embodiment, the challenge-response module 401c interrupts the play of the multimedia content for presenting the random challenge to the user, and resumes the play of the multimedia content after the user provides one or more responses to the presented random challenge.

The report generation module 401d generates a response report based on the response from the user. The response determines whether the user viewed the targeted multimedia content. In an embodiment where the view confirmation module 401a is provided on the user's client device 401, the report generation module 401d transmits the generated response report to the multimedia distribution platform 402. The response report is also generated by the view confirmation module 401a on the multimedia distribution platform 402 in the online mode.

The payment module 402h compensates the user by crediting the user with one or more items of value based on, for example, the user opting to receive the targeted multimedia content from the multimedia distribution platform 402, viewing of the targeted multimedia content by the user, referring of the targeted multimedia content by the user to one or more other users, the rating of the acquired marketing data of the user, etc. The payment module 402h determines the number of items of value to be credited to the user based on the rating of the acquired marketing data of the user.

The data store 402i of the multimedia distribution platform 402 stores the multimedia content, the marketing data acquired from the user, the marketing specific challenges, responses of the user to the marketing specific challenges, the rating of the acquired marketing data of the user, preferences of the user, etc. The data store 402i stores the multimedia content and a predetermined list of marketing data tagged with multimedia content.

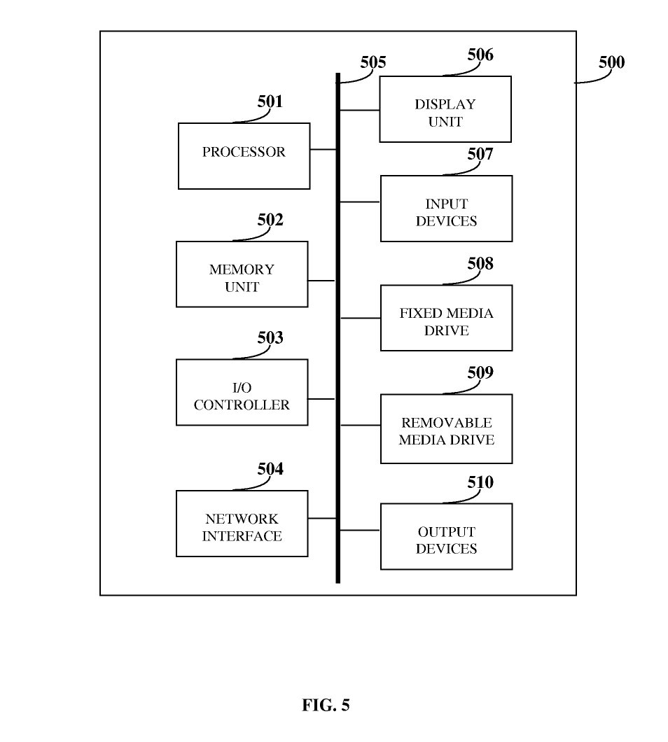

FIG. 5 exemplarily illustrates the architecture of a computer system 500 employed on the client device 401 and the multimedia distribution platform 402. The computer system 500 executes the view confirmation module 401a. The computer system 500 comprises a processor 501, a memory unit 502 for storing programs and data, an input/output (I/O) controller 503, a network interface 504, and a display unit 506 communicating via a data bus 505.

The memory unit 502 comprises a random access memory (RAM) and a read only memory (ROM). The computer system 500 further comprises one or more input devices 507, for example, a keyboard such as an alphanumeric keyboard, a mouse, a joystick, a touch-sensitive screen, a voice recognition system, etc. The input devices 507 are used for inputting data into the computer system 500. The I/O controller 503 controls the input and output actions performed by the user. The computer system 500 communicates with other computer systems through the network interface 504, comprising, for example, a Bluetooth® interface, an infrared (IR) interface, a WiFi interface, a universal serial bus interface (USB), a local area network or wide area network (LAN or WAN) interface, etc.

The computer system 500 further comprises a fixed media drive 508 and a removable media drive 509 for receiving removable media. The computer system 500 further comprises output devices 510, for example, a printer for receiving and reading digital data on a compact disk, a digital video disk or other medium. Computer applications or programs are used for operating the computer system 500. The programs are loaded onto the fixed media drive 508 and into the memory unit 502 of the computer system 500, for example, via the removable media drive 509. In an embodiment, the computer applications and programs may be loaded directly via the network 404. Applications are executed by double clicking a related icon or menu displayed on the display unit 506 using the input devices 507.

The computer system 500 of the client device 401 and the multimedia distribution platform 402 employ an operating system for performing multiple tasks. The operating system is responsible for the management and coordination of activities and the sharing of the resources of the computer system 500. The operating system further manages security of the computer system 500, peripheral devices connected to the computer system 500, and network connections. The operating system recognizes keyboard inputs and pointing device inputs of a user, output display, files and directories stored locally on the fixed media drive 508. Different programs, for example, a web browser, electronic mail (email) application, etc. initiated by the user are executed by the operating system with the help of the processor 501, for example, a central processing unit (CPU). The operating system monitors the use of the processor 501. The operating system on the computer system 500 executes different modules initiated by the client device 401 and the multimedia distribution platform 402 using the processor 501. The location of the instructions in the program memory is determined by a program counter (PC).

The instructions fetched by the processor 501 from the program memory after being processed are decoded. After processing and decoding, the processor 501 executes the instructions. For example, the data acquisition module 402b defines instructions for acquiring marketing data from the user via the interactive interface 402a. The authenticity determination module 402c defines instructions for determining authenticity of the acquired marketing data of the user. The challenge presentation module 402d defines instructions for generating and presenting one or more marketing specific challenges to the user on the interactive interface 402a based on the acquired marketing data. The response analysis module 402e defines instructions for obtaining one or more responses to the presented marketing specific challenges from the user via the interactive interface 402a and analyzing the obtained responses using one or more marketing databases 403 to determine the authenticity of the acquired marketing data of the user. The authenticity determination module 402c defines instructions for identifying and rectifying inconsistencies in the acquired marketing data of the user using one or more marketing databases 403. The challenge presentation module 402d defines instructions for generating additional marketing specific challenges to determine authenticity of the acquired marketing data of the user by utilizing the acquired marketing data, the marketing databases 403, and the rating of the acquired marketing data of the user.

The rating engine 402f defines instructions for rating the acquired marketing data of the user based on the determined authenticity of the acquired marketing data. The rating engine 402f further defines instructions for varying the rating of the acquired marketing data of the user based on inconsistencies in the acquired marketing data of the user, one or more marketing specific challenges, time, and purchase information. The rating engine 402f further defines instructions for providing recommendations to the user for improving the rating of the acquired marketing data of the user. The targeting module 402g defines instructions for targeting the multimedia content to the user based on, for example, the acquired marketing data of the user, the determined authenticity, the rating of the acquired marketing data of the user, external marketing data obtained from one or more marketing databases 403, etc.

The view confirmation module 401a provided on the client device 401 and/or the multimedia distribution platform 402 defines instructions for the challenge generator 401b, the challenge-response module 401c, and the report generation module 401d. The challenge generator 401b defines instructions for generating a random challenge that is one or more of random in content, presented at random times during and/or after play of the targeted multimedia content, and presented at random physical locations on the targeted multimedia content. The challenge-response module 401c defines instructions for presenting the generated random challenge to the user on the display screen 401e of the client device 401 by overlaying the generated random challenge on the targeted multimedia content or inserting the generated random challenge on interruption of the play of the targeted multimedia content. The challenge-response module 401c defines instructions for presenting one or more random challenges at one or more times during and/or after the multimedia content is played. The challenge-response module 401c defines instructions for invoking a response from the user for the presented random challenge. The report generation module 401d defines instructions for generating a response report based on the response from the user.

The payment module 402h defines instructions for compensating the user by crediting the user with one or more items of value based on the user opting to receive the targeted multimedia content from the multimedia distribution platform 402, viewing of the targeted multimedia content by the user, referring of the targeted multimedia content to one or more other users by the user, and the rating of the acquired marketing data. The payment module 402h defines instructions for determining the number of items of value to be credited to the user based on the rating of the acquired marketing data of the user. The data store 402i defines instructions for storing the multimedia content, the marketing data acquired from the user, the marketing specific challenges, responses of the user to the marketing specific challenges, the rating of the acquired marketing data of the user, and preferences of the user. The defined instructions are stored in the program memory or received from a remote server.

The processor 501 of the multimedia distribution platform 402 retrieves the instructions defined by the challenge generator 401b, the challenge-response module 401c, and the report generation module 401d of the view confirmation module 401a, the data acquisition module 402b, the authenticity determination module 402c, the challenge presentation module 402d, the response analysis module 402e, the rating engine 402f, the targeting module 402g, and the payment module 402h and executes the instructions. The processor 501 of the client device 401 retrieves instructions defined by the challenge generator 401b, the challenge-response module 401c, and the report generation module 401d of the view confirmation module 401a and executes the instructions.

The instructions from the view confirmation module 401a are stored in the memory unit 502. The multimedia content is transferred from the data store 402i to the view confirmation module 401a through the network interface 504 via the network 404. A user initiates the execution of the view confirmation module 401a by double clicking on the icon for the view confirmation module 401a on the display unit 506 or the execution of the view confirmation module 401a is automatically initiated on transmitting multimedia content to the view confirmation module 401a. The processor 501 retrieves instructions for executing the view confirmation module 401a from various modules, for example, the challenge generator 401b, the challenge-response module 401c, and the report generation module 401d in the view confirmation module 401a. The locations of the instructions in the modules 401b, 401c, and 401d are determined by a program counter (PC). The program counter stores a number that identifies the current position in the program of the view confirmation module 401a. The instructions fetched by the processor 501 from the program memory after being processed are decoded. The instructions are placed in an instruction register (IR) in the processor 501. After processing and decoding, the processor 501 executes the instructions. The instructions comprise, for example, rendering the multimedia content selected by the user, presenting a random challenge by overlaying the random challenge on the multimedia content, generating a response report for the user, etc. At the time of execution, the instructions stored in the instruction register are examined to determine the operations to be performed. The specified operation is then performed by the processor 501. The operations include arithmetic and logic operations.

The operating system performs multiple routines for performing a number of tasks required to assign input devices 507, the output devices 510, and the memory unit 502 for execution of the view confirmation module 401a. The tasks performed by the operating system comprise assigning memory to the view confirmation module 401a and data, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the view confirmation module 401a are displayed to the user on the display unit 506.

For purposes of illustration, the detailed description refers to the multimedia distribution platform 402 being run locally on a computer system 500; however the scope of the computer implemented method and system 400 disclosed herein is not limited to the multimedia distribution platform 402 being run locally on a computer system 500 via the operating system and the processor 501 but may be extended to run remotely over the network 404 by employing a web browser and a remote server, a mobile phone, or other electronic devices.

The multimedia distribution platform 402 for confirming viewing of multimedia content by the user may also be implemented on operating systems, for example, Windows Mobile® of Microsoft Corporation, Symbian, Google™ Android, or the Apple® iPhone, for mobile devices. Mobile implementation uses similar algorithms but may involve different hardware interfaces. For example, selection of the list of targeted multimedia content and viewing parameters such as schedule, order of playing the targeted multimedia content by the user may be performed via a touch screen or voice recognition, and messages may be created using an on-screen keypad or slide-out keyboard, communicating with client software on the mobile device or in a mobile browser. Message transmission then occurs using the mobile device's internet capabilities via a network 404, for example, a WiFi network, a satellite network, a cellular network, etc. The multimedia distribution platform 402 may also be implemented on two different devices, for example, a desktop and a mobile device, to facilitate communication between them.

FIGS. 6A-6I exemplarily illustrate screenshots of an interactive interface 402a provided by the multimedia distribution platform 402. A user accesses the multimedia distribution platform 402 via the interactive interface 402a. The user creates a user account on the multimedia distribution platform 402. The user creates a user profile associated with the user account by providing, for example, name, contact information, address information, payment information, etc. as exemplarily illustrated in FIG. 6A. The user may opt-in to receive the multimedia content during the creation of the user account. The multimedia distribution platform 402 confirms saving of the user's profile as exemplarily illustrated in FIG. 6B. The multimedia distribution platform 402 presents marketing specific challenges related to, for example, choices of cuisine, favorite music artist, buying preferences, product preferences, etc. to the user as exemplarily illustrated in FIGS. 6C-6D. The user responds to the marketing specific challenges either at each login to the multimedia distribution platform 402 or occasionally. The multimedia distribution platform 402 acquires marketing data from the user and provides an overall summary of the acquired marketing data of the user as exemplarily illustrated in FIGS. 6C-6D. For example, the user may enter “Lady Gaga” as their favorite music artist. The multimedia distribution platform 402 targets multimedia content to the user based on the responses obtained for the marketing specific challenges. For example, the multimedia distribution platform 402 may target Lady Gaga's latest music video to the user as exemplarily illustrated in FIG. 6E. In an embodiment, the multimedia distribution platform 402 may interrupt the play of the music video for presenting additional marketing specific challenges related to, for example, buying preferences, movie preferences, etc. as exemplarily illustrated in FIGS. 6F-6G. The multimedia distribution platform 402 confirms the viewing of the targeted music video as exemplarily illustrated in FIGS. 6H-6I. For example, the multimedia distribution platform 402 presents a random challenge on the targeted music video as exemplarily illustrated in FIG. 6H. The multimedia distribution platform 402 invokes a response from the user for confirming viewing of the targeted music video. The multimedia distribution platform 402 verifies the correctness of the response to confirm viewing of the targeted music video and provides the user with an offer as exemplarily illustrated in FIG. 6I. The multimedia distribution platform 402 inserts an interactive promotional segment, for example, a clickable coupon, within the targeted multimedia content as exemplarily illustrated in FIG. 6I. The clickable coupon directs the user to a commercial transaction platform for enabling the user to purchase products, for example, digital versatile discs (DVDs) and services on the commercial transaction platform.

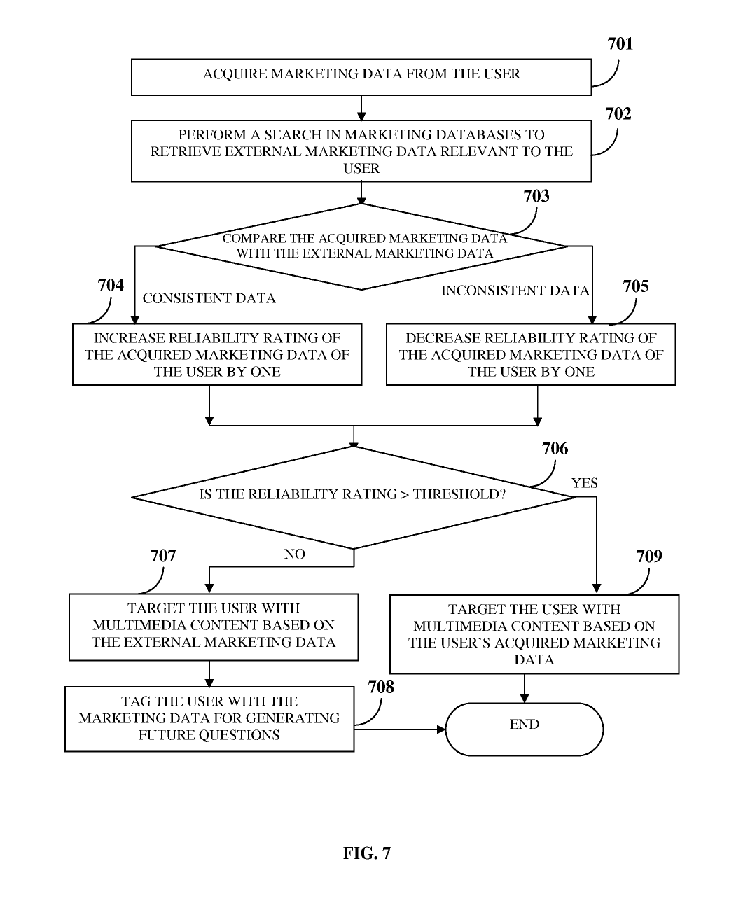

FIG. 7 exemplarily illustrates a flow diagram for targeting multimedia content to a user based on authenticity of marketing data of the user. The multimedia distribution platform 402 acquires 701 marketing data from the user's responses to one or more marketing specific challenges presented by the multimedia distribution platform 402. The multimedia distribution platform 402 performs 702 a search in one or more marketing databases 403 to retrieve external marketing data relevant to the user. The multimedia distribution platform 402 combines the responses to the marketing specific challenges from the user with other known information about the user to retrieve equivalent external marketing data from the marketing databases 403. The multimedia distribution platform 402 compares 703 the acquired marketing data with the external marketing data for consistency. If the acquired marketing data is consistent with the external marketing data, the multimedia distribution platform 402 increases 704 the reliability rating of the user's acquired marketing data, for example, by one. If the acquired marketing data is inconsistent with the external marketing data, the multimedia distribution platform 402 decreases 705 the reliability rating of the acquired marketing data of the user, for example, by one. The multimedia distribution platform 402 examines 706 the aggregate reliability rating with reference to a predetermined threshold. For example, if the aggregate reliability rating is less than zero, the multimedia distribution platform 402 determines that the user's acquired marketing data is unreliable and targets 707 the user with multimedia content based on the external marketing data. The multimedia distribution platform 402 then tags 708 the user with the marketing data for generating future questions for the user. The multimedia distribution platform 402 determines the nature of data inconsistency using the marketing databases 403. If the aggregate reliability rating is greater than one, the multimedia distribution platform 402 considers the acquired marketing data of the user as authentic and targets 709 the user with multimedia content based on the acquired marketing data of the user.

For each marketing specific challenge related to, for example, income, education, music preference, etc. the multimedia distribution platform 402 provides the user with a reliability rating that is either positive or negative based on the increase or decrease in the reliability rating. For example, a negative reliability rating directs the targeting of the multimedia content to the user based on the external marketing data in the marketing databases 403, whereas a positive reliability rating directs the targeting of the multimedia content to the user based on the user's responses or the marketing data acquired from the user. The reliability rating accounts for the fact that a user might be true in one area, for example, music and not true in another area, for example, income.

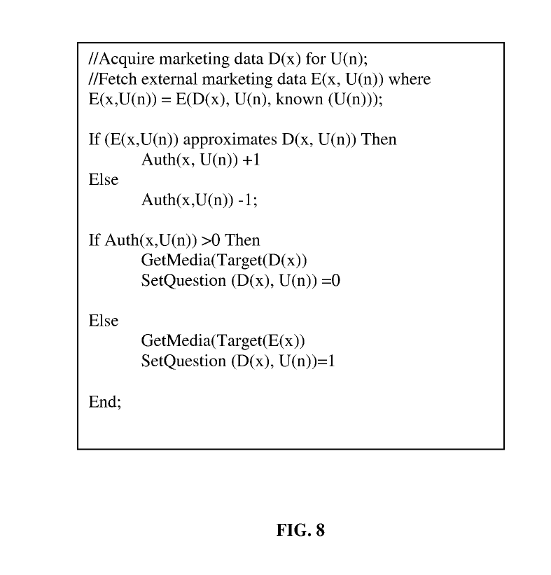

FIG. 8 exemplarily illustrates a sample pseudocode for targeting multimedia content to a user based on a reliability rating of the acquired marketing data of the user. The pseudocode may be implemented using, for example, Microsoft® Visual Studio® of Microsoft Corporation. The user is referenced herein by U(n), where “n” is the number or identifier of the user. The marketing data acquired from the user is referenced herein by D(x), where “x” is an element of marketing data, for example, demographic data, psychographic data, etc. The reliability rating of the user is represented by “Auth(x,U(n))”.

The marketing data D(x) is acquired from the user using a marketing specific challenge or question. The marketing data D(x) of the user U(n) is used in combination with known data, for example, area code, age, income, etc. of the user U(n) to fetch or retrieve equivalent external marketing data E(x) from the marketing databases 403. The external marketing data E(x) of the user U(n) and the acquired marketing data D(x) provided by the user U(n) are compared for consistency. If the E(x) values are consistent with the D(x) values of the user U(n), the reliability rating, represented by Auth(x,U(n)), of the user U(n) for the element “x” is increased by a factor, for example, by one. The reliability rating grows over a period of time for the element “x”. If the marketing data D(x) remains consistent for the element “x”, the reliability rating grows further with time as more consistent marketing data is received. If the E(x) values are inconsistent with the D(x) values of the user U(n), the reliability rating, represented by Auth(x,U(n)), of the user U(n) for the element “x”, is decreased by a factor, for example, by one.

If the reliability rating of the user for the element “x” is less than a predetermined threshold, then the external marketing data E(x) of the user is considered authentic and is used to target the user U(n) with relevant multimedia content. If the reliability rating is less than the predetermined threshold, the combination of the marketing data D(x) and the user U(n) is stored in a question variable, SetQuestion(D(x), U(n)) and the question variable SetQuestion(D(x), U(n)) is set to one. The flagged value of SetQuestion(D(x), U(n)) is used to target future questions to the user U(n) in the element “x” that assist in determining the authenticity of the user's responses. If the reliability rating of the user U(n) for the element “x” is greater than a predetermined threshold, then the user's marketing data D(x) is considered authentic and is used to target the user U(n) with relevant multimedia content. If the reliability rating of the user is greater than the predetermined threshold, then the future question flag for this element “x”, namely, SetQuestion(D(x), U(n)) is set to zero. If the question variable SetQuestion(D(x), U(n)) is set to zero, the user will not be targeted for special questioning in the element “x” in the future.

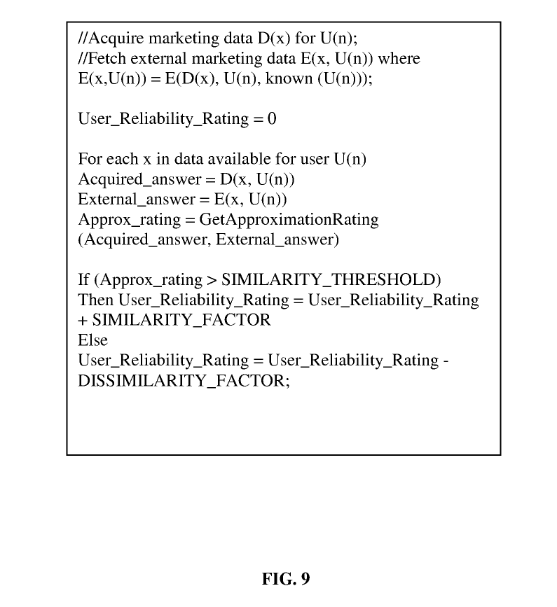

FIG. 9 exemplarily illustrates another sample pseudocode for targeting multimedia content to a user based on a reliability rating of the acquired marketing data of the user. The user, the marketing data acquired from the user, and the external marketing data are denoted by U(n), D(x), and E(x) respectively as disclosed in the detailed description of FIG. 8, wherein “n” is the number or identifier of the user and “x” is an element of marketing data, for example, demographic data, psychographic data, etc. For each element “x”, the multimedia distribution platform 402 acquires an answer or a response from the user, wherein the answer is the acquired marketing data of the user U(n) represented by D(x, U(n)). The multimedia distribution platform 402 further acquires an answer or a response for each element “x” from the marketing databases 403, wherein the answer is the external marketing data represented by E(x, U(n)). The multimedia distribution platform 402 determines the reliability rating, represented by “Approx_rating”, of the user U(n) for each element “x”. The multimedia distribution platform 402 then compares the reliability rating with a predetermined threshold. If the reliability rating is greater than the predetermined threshold, the reliability rating is increased by a similarity factor. If the reliability rating is lesser than the predetermined threshold, the reliability rating is decreased by a dissimilarity factor. In an embodiment, the reliability rating may be converted to an adjustment score, for example, if two answers are an absolute score distance apart from each other, a function may be invoked for converting the reliability rating to an adjustment score that can be used as the aggregate reliability rating. The multimedia distribution platform 402 then utilizes the aggregate reliability rating to determine whether the multimedia content should be targeted to the user based on the acquired marketing data or the external marketing data from the marketing databases 403.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, Perl, Python, or JAVA. The software programs may be stored on or in one or more mediums as an object code. A computer program product comprising computer executable instructions embodied in a computer readable medium comprises computer parsable codes for the implementation of the processes of various embodiments.

Where databases are described such as the data store 402i and the marketing databases 403, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases can be used to store and manipulate the data types described herein. Likewise, object methods or behaviors of a database can be used to implement various processes, such as those described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for targeting multimedia content based on authenticity of marketing data of a user, comprising:
providing a multimedia distribution platform comprising an interactive interface;
acquiring marketing data from said user by said multimedia distribution platform via said interactive interface;
determining authenticity of said acquired marketing data of said user by said multimedia distribution platform;
rating said acquired marketing data of said user based on said determined authenticity by said multimedia distribution platform; and
targeting said multimedia content to said user based on one or more of said determined authenticity and said rating of said acquired marketing data of said user by said multimedia distribution platform.

2. The computer implemented method of claim 1, wherein said determination of said authenticity of said acquired marketing data of said user by said multimedia distribution platform, comprises:
presenting one or more marketing specific challenges to said user on said interactive interface based on said acquired marketing data;
obtaining one or more responses to said one or more marketing specific challenges from said user via said interactive interface; and
analyzing said obtained one or more responses using one or more marketing databases to determine said authenticity of said acquired marketing data of said user.

3. The computer implemented method of claim 2, wherein said determination of said authenticity of said acquired marketing data further comprises identifying and rectifying inconsistencies in said acquired marketing data of said user using said one or more marketing databases.

4. The computer implemented method of claim 3, wherein said inconsistencies in said acquired marketing data of said user are identified by presenting one or more additional marketing specific challenges to said user on said interactive interface by said multimedia distribution platform.

5. The computer implemented method of claim 1, wherein said multimedia distribution platform varies said rating of said acquired marketing data of said user based on inconsistencies in said acquired marketing data of said user, one or more marketing specific challenges, time, and purchase information.

6. The computer implemented method of claim 1, wherein said multimedia distribution platform utilizes one or more of said acquired marketing data, one or more marketing databases, and said rating for generating additional marketing specific challenges to determine said authenticity of said acquired marketing data of said user and for providing feedback on said authenticity of the acquired marketing data.

7. A computer implemented method for targeting multimedia content based on authenticity of marketing data of a user and compensating said user based on viewing of said targeted multimedia content, comprising:
providing a multimedia distribution platform comprising an interactive interface;
acquiring marketing data from said user by said multimedia distribution platform via said interactive interface;
determining authenticity of said acquired marketing data of said user by said multimedia distribution platform;
rating said acquired marketing data of said user based on said determined authenticity by said multimedia distribution platform;
targeting said multimedia content to said user based on one or more of said determined authenticity and said rating of said acquired marketing data of said user by said multimedia distribution platform;
confirming viewing of said targeted multimedia content on a client device of said user using a random challenge, wherein said random challenge is one or more of:
random in content;
presented at random times during and/or after play of said targeted multimedia content; and
presented at random physical locations on said targeted multimedia content; and
compensating said user by crediting said user with one or more items of value based on one or more of said viewing of said targeted multimedia content and said rating of said acquired marketing data of said user.

8. The computer implemented method of claim 7, wherein said confirming said viewing of said targeted multimedia content by said user, comprises:
generating said random challenge;
presenting said generated random challenge to said user by one of overlaying said generated random challenge on said targeted multimedia content, and inserting said generated random challenge on interruption of said play of said targeted multimedia content;
invoking a response from said user for said presented random challenge; and
generating a response report based on said response from said user, wherein said response determines whether said user has viewed said targeted multimedia content.

9. The computer implemented method of claim 7, wherein said multimedia distribution platform determines number of said one or more items of value to be credited to said user based on said rating of said acquired marketing data of said user.

10. The computer implemented method of claim 7, further comprising presenting a commercial transaction opportunity for said user by said multimedia distribution platform, for enabling purchasing of one or more products and services by said user using said credited one or more items of value.

11. The computer implemented method of claim 7, wherein said targeting of said multimedia content to said user by said multimedia distribution platform is based on one or more of preferences selected by said user, said acquired marketing data of said user, said determined authenticity, said rating of said acquired marketing data of said user, and external marketing data obtained from one or more marketing databases.

12. The computer implemented method of claim 7, further comprising creating a user account on said multimedia distribution platform by said user, wherein said user opts in to receive said multimedia content during said creation of said user account.

13. The computer implemented method of claim 7, wherein said compensation of said user is based on one or more of:
opting to receive said targeted multimedia content by said user from said multimedia distribution platform;
confirming said viewing of said targeted multimedia content by said user; and
referring of said targeted multimedia content by said user to one or more other users.

14. A computer implemented method for targeting multimedia content based on authenticity of marketing data of a user, comprising:
providing a multimedia distribution platform comprising an interactive interface;
acquiring marketing data from said user by said multimedia distribution platform via said interactive interface;
identifying and rectifying inconsistencies in said acquired marketing data from said user by said multimedia distribution platform using one or more marketing databases;
rating said acquired marketing data of said user based on said identified and rectified inconsistencies by said multimedia distribution platform; and
targeting said multimedia content to said user based on said rating of said acquired marketing data of said user by said multimedia distribution platform.

15. The computer implemented method of claim 14, wherein said multimedia distribution platform provides recommendations to said user for improving said rating of said acquired marketing data of said user.

16. A computer implemented system for targeting multimedia content based on authenticity of marketing data of a user, comprising:
a multimedia distribution platform comprising:
a data acquisition module that acquires said marketing data from said user via an interactive interface;
an authenticity determination module that determines authenticity of said acquired marketing data of said user;
a rating engine that rates said acquired marketing data of said user based on said determined authenticity;
a targeting module that targets said multimedia content to said user based on one or more of said acquired marketing data of said user, said determined authenticity, said rating of said acquired marketing data of said user, and external marketing data obtained from one or more marketing databases; and
a client device connected to said multimedia distribution platform via a network, wherein said client device receives said targeted multimedia content from said multimedia distribution platform and plays said targeted multimedia content on a display screen of said client device.

17. The computer implemented system of claim 16, wherein said authenticity determination module comprises:
a challenge presentation module that generates and presents one or more marketing specific challenges to said user on said interactive interface based on said acquired marketing data; and
a response analysis module that obtains one or more responses to said one or more marketing specific challenges from said user via said interactive interface and analyzes said obtained one or more responses using said one or more marketing databases to determine said authenticity of said acquired marketing data of said user.

18. The computer implemented system of claim 17, wherein said challenge presentation module utilizes one or more of said acquired marketing data, said one or more marketing databases, and rating of said acquired marketing data of said user for generating additional marketing specific challenges to determine said authenticity of said acquired marketing data of said user.

19. The computer implemented system of claim 16, wherein said authenticity determination module identifies and rectifies inconsistencies in said acquired marketing data of said user using said one or more marketing databases.

20. The computer implemented system of claim 16, wherein said rating engine varies said rating of said acquired marketing data of said user based on inconsistencies in said acquired marketing data of said user, one or more marketing specific challenges, time, and purchase information.

21. The computer implemented system of claim 16, further comprising a view confirmation module on one of said multimedia distribution platform and said client device, wherein said view confirmation module comprises:
a challenge generator that generates a random challenge, wherein said random challenge is one or more of:
random in content;
presented at random times during and/or after play of said targeted multimedia content; and
presented at random physical locations on said targeted multimedia content;
a challenge-response module that presents said generated random challenge to said user on said display screen of said client device by one of overlaying said generated random challenge on said targeted multimedia content, and inserting said generated random challenge on interruption of said play of said targeted multimedia content, wherein said challenge-response module invokes a response from said user for said presented random challenge;
said challenge-response module that determines whether said user has entered said response for said presented random challenge to confirm that said user viewed said targeted multimedia content; and
a report generation module that generates a response report based on said response from said user, wherein said response determines whether said user viewed said targeted multimedia content.

22. The computer implemented system of claim 16, wherein said multimedia distribution platform further comprises a payment module that compensates said user by crediting said user with one or more items of value based on one or more of viewing of said targeted multimedia content and said rating of said acquired marketing data of said user.

23. The computer implemented system of claim 22, wherein said payment module determines number of said one or more items of value to be credited to said user based on said rating of said acquired marketing data of said user.

24. The computer implemented system of claim 16, wherein said multimedia distribution platform further comprises a data store for storing one or more of said multimedia content, said acquired marketing data of said user, said one or more marketing specific challenges, said responses of said user to said one or more marketing specific challenges, said rating of said acquired marketing data of said user, and one or more preferences of said user.

25. A computer program product comprising computer executable instructions embodied in a computer readable storage medium, wherein said computer program product comprises:
a first computer parsable program code for acquiring marketing data from a user via an interactive interface provided by a multimedia distribution platform;
a second computer parsable program code for determining authenticity of said acquired marketing data of said user;
a third computer parsable program code for rating said acquired marketing data of said user based on said determined authenticity;
a fourth computer parsable program code for targeting said multimedia content to said user based on one or more of said determined authenticity and said rating of said acquired marketing data of said user;
a fifth computer parsable program code for confirming viewing of said targeted multimedia content on a client device of said user using a random challenge; and
a sixth computer parsable program code for compensating said user by crediting said user with one or more items of value based on one or more of said viewing of said targeted multimedia content and said rating of said acquired marketing data of said user.
